(19) United States
(12) Patent Application Publication
(10) Pub. No.: US 2007/0294776 A1
(43) Pub. Date: Dec. 20, 2007

(54) COMPUTER USER AUTHENTICATION SYSTEM

(75) Inventor: Katsunori IKAKE, Osaka-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: HMI Co., Ltd., Osaka-shi (JP)

(21) Appl. No.: 11/424,137

(22) Filed: Jun. 14, 2006

(51) Int. Cl. G06F 17/30; H04L 9/00; G06F 7/04; G06K 9/00; H03M 1/68; H04K 1/00; H04L 9/32; H04N 7/16

(52) U.S. Cl. 726/30; 713/168; 726/31

(57) ABSTRACT

A computer authentication system is provided with a random number generator 5 for generating a random number on the basis of a noise signal generated by a noise generator and a code rewriter for creating a new encryption code on the basis of the random number generated by the random number generator 5 when the encryption code of a computer 1 corresponds to the encryption code of an authentication key 2, rewriting the encryption code recorded in a encryption recorder 19 of the computer 1 to the new encryption code and rewriting the encryption code recorded in an encryption recorder 10 of the authentication key 2 to the new encryption code.

### BACKGROUND OF THE INVENTION

The present invention relates to a user authentication system that can permit the use of a computer when an authentication key is attached to the computer.

Conventionally, a user authentication system has been known in which by inserting an authentication key (IC card) into a computer (terminal device) and inputting a password to the computer, the password of the computer is collated with the password of the authentication key through predetermined processing and when these passwords correspond to each other, the use of the computer is permitted. This type of user authentication system is disclosed in, for example, Japanese Unexamined Patent Publication No. 1993-290225.

In the user authentication system, in inserting the authentication key into the computer, a pseudorandom number is generated on the side of the authentication key and the password is encrypted on the side of the computer using the pseudorandom number. Furthermore, in the user authentication system, an encryption code encrypted by the pseudorandom number is transmitted to the authentication key, the transmitted encryption code is restored to a random number on the basis of the password recorded in the authentication key and the restored random number is collated with the pseudorandom number used at encryption to determine whether or not the use of the computer is permitted.

However, since the password input to the computer is encrypted on the basis of the pseudorandom number generated by the authentication key, a pattern generated through the pseudorandom number can be decoded. As a result, there is a possibility that the password (encryption code) is decoded and the computer is used in an unauthorized manner.

### SUMMARY OF THE INVENTION

Accordingly, in consideration of the above-mentioned problem, the present invention intends to provide a computer user authentication system by which an encryption code for using a computer is hard to be decoded and thus, unauthorized operation of the computer can be prevented.

A technical means of the present invention for solving the technical problem is a computer user authentication system including a computer that records an encryption code therein and an authentication key that stores an encryption code therein. The computer has a controller for collating the encryption code of the computer with the encryption code of the authentication key and for permitting the use of the computer when both encryption codes correspond to each other. The authentication key includes a random number generator for generating a random number on the basis of a noise signal generated by a noise source, and a code rewriter for creating a new encryption code on the basis of the random number generated by the random number generator when the encryption code of the computer corresponds to the encryption code of the authentication key and for rewriting the encryption code recorded in the authentication key to the new encryption code. The computer includes a code rewriter for creating a new encryption code on the basis of the random number generated by the random number generator when the encryption code of the computer corresponds to the encryption code of the authentication key and for rewriting the encryption code recorded in the computer to the new encryption code.

In another technical means of the present invention for solving the problem, the authentication key includes a random number generation controller for controlling the random number generator so as to generate the random number when the code rewriter of the authentication key rewrites the encryption code to the new encryption code.

In another technical means of the present invention for solving the problem, the code rewriter rewrites the encryption code when the encryption code of the computer corresponds to the encryption code of the authentication key and the number of times that the authentication key permits the use of the computer reaches a predetermined number of times.

In another technical means of the present invention for solving the problem, an ID code is recorded in the computer and the controller of the computer permits the use of the computer when the encryption code of the computer corresponds to the encryption code of the authentication key and the code input to the computer corresponds to the ID code.

In another technical means of the present invention for solving the problem, the authentication key can be connected to an interface of the computer and the authentication key transmits the encryption code of the authentication key to the computer when the authentication key is connected to the interface of the computer.

In another technical means of the present invention for solving the problem, the controller of the computer includes a locking unit for making the computer unusable when the authentication key connected to the interface of the computer is pulled from the interface of the computer so that computer operation may be performed from the state immediately before the pulling-out of the authentication key when the authentication key is connected to the interface of the computer again.

### BRIEF DESCRIPTION OF THE DRAWINGS

FIG. 1 is a configuration view of a computer user authentication system according to the present invention;

FIG. 2 is a configuration view of a random number generator;

FIG. 3 is an explanation view of a noise signal and sampling;

FIG. 4 is a timing chart of the noise signal binarized on a sampling clock;

FIG. 5 is an operational flowchart of the computer user authentication system at activation of a computer;

FIG. 6 is an operational flowchart of the computer user authentication system when an authentication key is pulled out the computer; and

FIG. 7 is an operational flowchart of the computer user authentication system in a locking state of the computer.

### DESCRIPTION OF PREFERRED EMBODIMENTS

Hereinafter, an embodiment of the present invention will be described referring to figures.

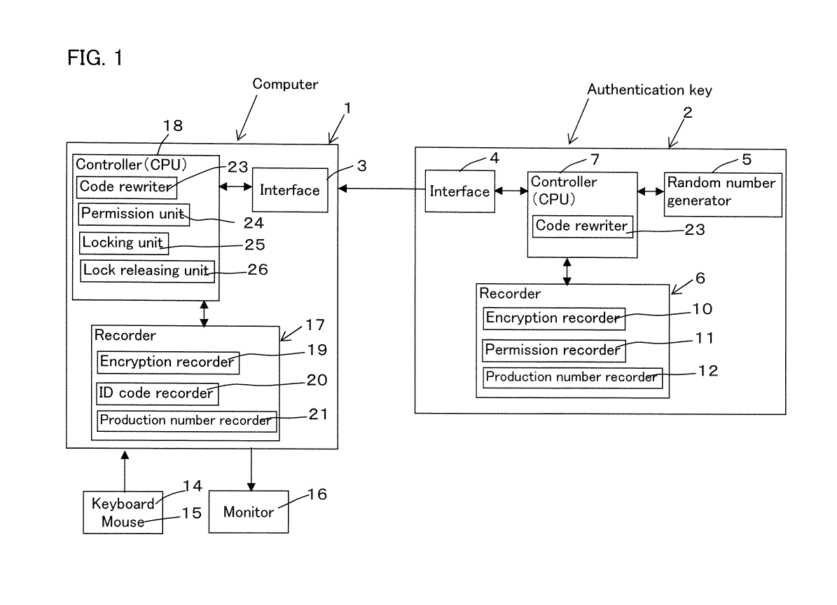

As shown in FIG. 1, a computer user authentication system has a computer 1 and an authentication key 2 for authorizing the use of the computer 1.

The authentication key 2 can be connected to an interface 3 (for example, an USB interface) of the computer 1 and has an interface 4 that can be connected to the interface 3, a random number generator 5, a recorder 6 (storage) and a controller 7 (CPU) that can control the user authentication system.

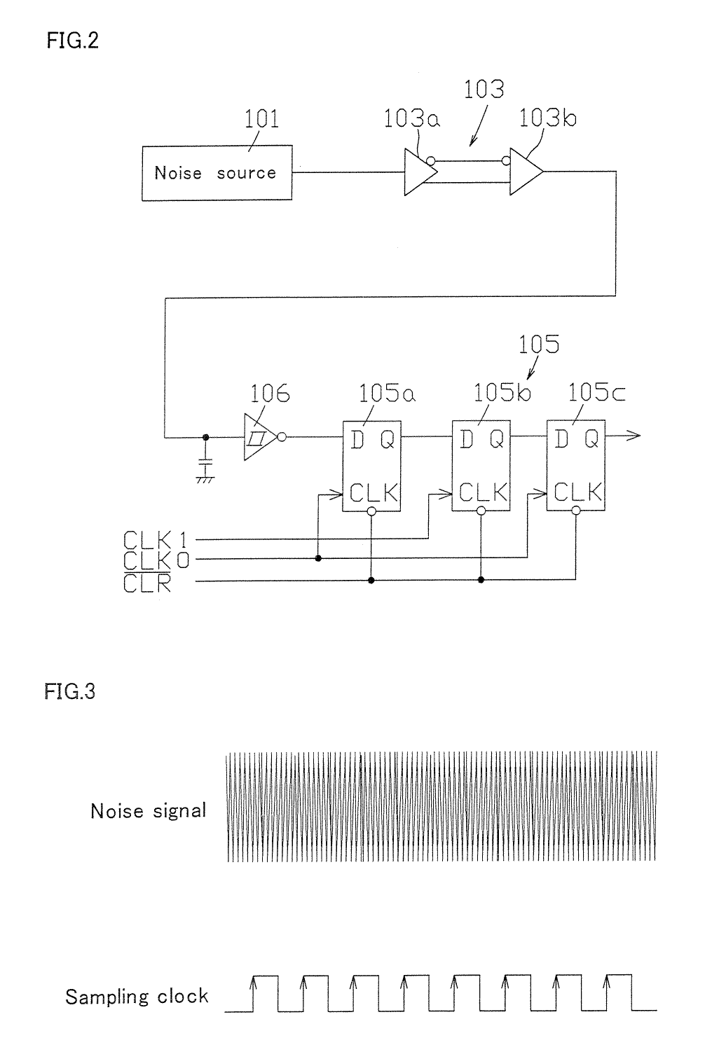

The random number generator 5, as shown in FIGS. 1 and 2, has a noise source 101 for outputting a noise signal, an amplifier 103 for amplifying the noise signal output from the noise source 101 and a binarization device 105 for binarizing the amplified noise signal.

The noise source 101 uses thermal noise of a semiconductor as noise and compared to the use of pseudorandom numbers, the use of the thermal noise of the semiconductor results in a non-cyclic random signal. The semiconductor as the noise source 101 is built in a device (IC) and any external part is unnecessary.

The amplifier 103 serves to amplify the noise of the noise source 101 and is formed of operational amplifiers 103a and 103b. As shown in FIG. 2, the noise signal amplified by the amplifier 103 is input to a Schmitt trigger gate 106 and a square wave having a pulse width depending on the magnitude of the noise signal is output. The Schmitt trigger is a circuit that allows an output pulse to rise (or fall) when an input voltage (noise signal) becomes a certain value or more and allows the output pulse to fall (or rise) when the input voltage (noise signal) becomes a certain value or less.

Thus, the analog noise signal is converted into a digital noise signal (TTL level) with a pulse width depending on the magnitude of the signal by the Schmitt trigger gate 106. As described above, the Schmitt trigger gate 106 functions as a converter for converting the noise signal into the digital noise signal (TTL level).

The binarization device 105 is formed of a serial register (also referred to as a serial shift register) using a sampling clock. An input of the serial register 105 is a noise signal and an output of 1 or 0 of the Schmitt trigger gate 106 (high voltage and low voltage) is input to the serial register 105. The serial register 105 is configured as a shift register having a serial input and serial output and operates on clocks CLK0 and CLK1. The clocks CLK0 and CLK1 are clocks with the same frequency having a phase difference of a half cycle between them.

The serial register 105 is formed by serially connecting D flip flops 105a, 105b and 105c in three stages (multi-stages), the clock CLK0 is given to a first stage 105a and third stage 105c and the clock CLK1 is given to a second stage 105b.

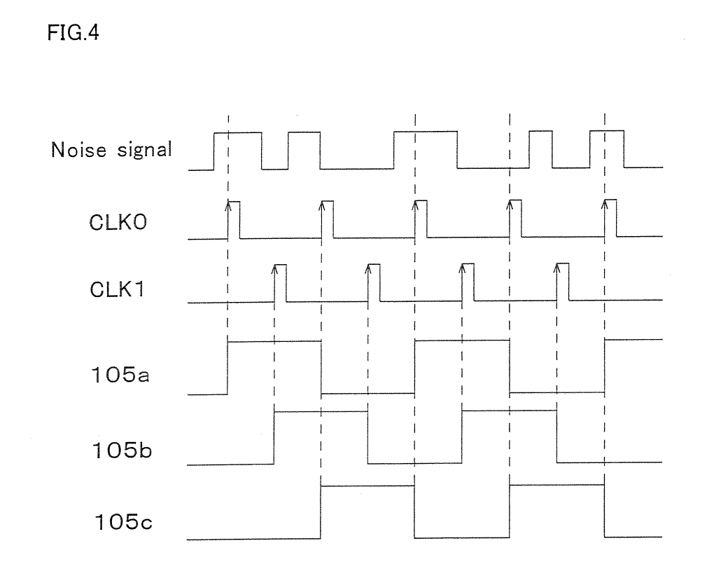

As shown in FIG. 3, the binarization device 105 binarizes the noise signal on the timing of the clock CLK0 (sampling clock). Describing in detail, as shown in FIG. 4, the pulse-like noise signal output from the Schmitt trigger gate 106 is sampled at a rising timing of the clock CLK0 signal by the first stage D flip flop 105a and an output Q of the first stage D flip flop 105a outputs 1 or 0 to become a value quantified (sampled) at the timing of the clock CLK0 as the sampling clock.

Then, the output of the first stage D flip flop 105a shifts to the second stage 105b at a rising timing of the clock CLK1 shifted by a half cycle.

At the next rising timing of the clock0, the first stage D flip flop 105a samples the noise signal again and an output of the second stage D flip flop 105b shifts to the third stage 105c. That is, the output is output from the serial register 105.

The above-mentioned operations are repeated and the sampling result of the first stage 105 appears the output of the serial register 105 with a delay of 1 cycle of the clock CLK0. As the noise signal is a random signal, a digital physical random number (true random number) in sync with the sampling CLK can be obtained by binarizing the noise signal. The random number generator 5 generates the true random number at all times due to the occurrence of the noise signal.

The recorder 6 of the authentication key 2 can record an encryption code created on the basis of a random number generated by the random number generator 5 and the number of times the use of the computer 1 is permitted by the authentication key 2. This recorder 6 has an encryption recorder 10 for recording the encryption code, a permission recorder 11 for recording a usage permission number and a production number recorder 12 for recording a production number (serial number) of the authentication key 2. The controller 7 of the authentication key 2 controls the above-mentioned interface 4, recorder 6 and random number generator 5.

The computer 1 is formed of, for example, a personal computer. An operating system (OS) is installed on the computer 1 for controlling desired application software and can manage data of clients, for example, by using the application software.

The computer 1 can be connected to an input device for inputting characters, numerals, etc. (a keyboard 14, a mouse 15) and a monitor 16 for displaying characters, numerals, images, etc.

Furthermore, the computer 1 has the interface 3 to which the authentication key 2 can be connected, a recorder 17 and a controller 18(CPU) capable of controlling the user authentication system.

The recorder 17 of the computer 1 can record the encryption code transmitted from the authentication key 2, a user's ID code and the production number of the authentication key 2. This recorder 17 has an encryption recorder 19 for recording the encryption code, ID code recorder 20 for recording the user's ID code and production number recorder 21 for recording the production number of the authentication key 2. The ID code recorder 20 records the ID code for identifying the user of the computer 1, that is, a password unique to the user therein.

The controller 18 of the computer 1 controls the interface 3, recorder 17, monitor 16 and the like.

The user authentication system comprised of the computer 1 and authentication key 2 is provided with a code rewriter 23 and the code rewriter 23 is provided in the controller 18 of the computer 1 and the controller 7 of the authentication key 2, respectively.

When the encryption code of the computer 1 corresponds to the encryption code of the authentication key 2, the code rewriter 23 creates a new encryption code based on the random number generated by the random number generator 5, rewrites the encryption code recorded in the encryption recorder 19 of the computer 1 and rewrites the encryption code recorded in the encryption recorder 10 of the authentication key 2 into the new encryption code.

The controller 18 of the computer 1 has a permission unit 24. The permission unit 24 permits the use of the computer when the encryption code of the computer 1 corresponds to the encryption code of the authentication key 2 and the code input to the computer 1 by the user corresponds to the ID code recorded in the computer 1.

On the other hand, the authentication key 2 is configured to transmit the encryption code of the authentication key 2 to the computer 1 so that the encryption code of the computer 1 may be collated with the encryption code of the authentication key 2 when the authentication key 2 is connected to the interface 3 of the computer 1.

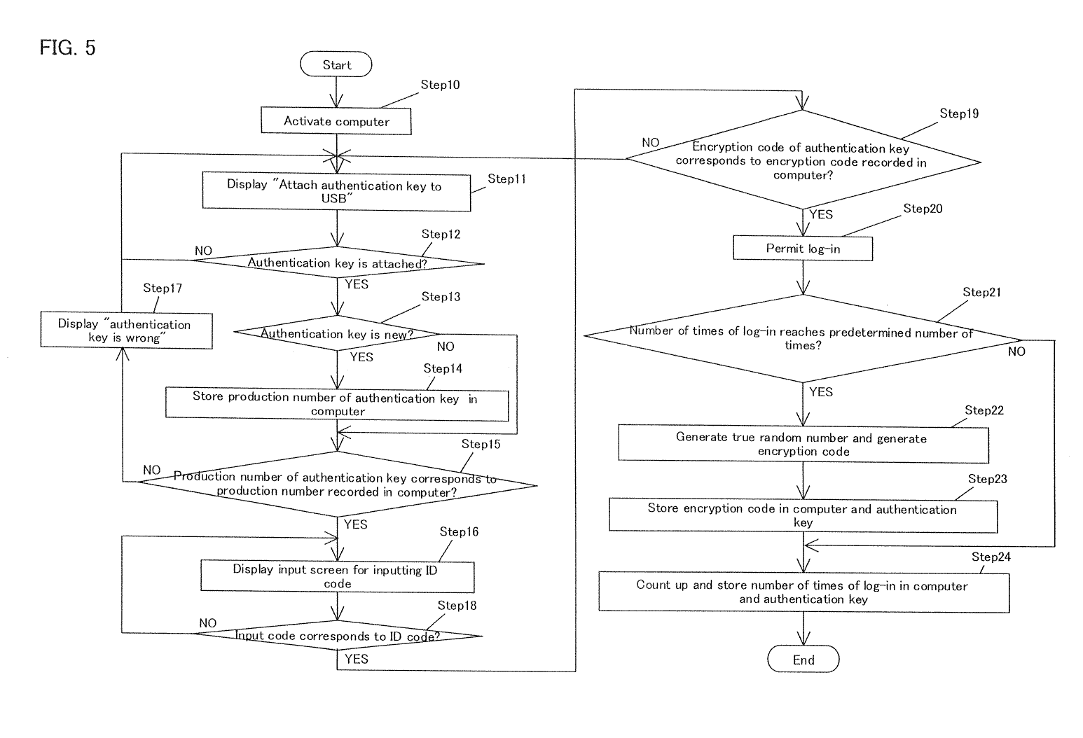

Operations of the user authentication system at activation of the computer 1 will be described referring to a flowchart in FIG. 5.

At step 10, when power of the computer 1 is turned on to activate the computer 1, a predetermined OS (for example, Windows made by Microsoft) installed in the computer 1 is started.

At step 11, when the OS starts up, the monitor 16 displays “Attach authentication key to USB” thereon according to a command of the controller 18 of the computer 1.

At step 12, the controller 18 of the computer 1 determines whether or not the authentication key 2 is connected (attached) to the interface 3 (USB) of the computer 1, when the authentication key 2 is attached to the interface 3, the procedure proceeds to step 13 and when the authentication key 2 is not attached to the interface 3, the procedure returns to step 11.

At step 13, the controller 18 determines whether or not the authentication key 2 is attached to the computer 1 for the first time. That is, the controller 18 determines whether or not the production number of the authentication key 2 is recorded in the production number recorder 21 of the computer 1 (determines whether or not the production number recorder 21 is blank). When the production number is not recorded, determination is made that the authentication key 2 is connected to the computer 1 for a first time and the procedure proceeds to step 14 and when the production number is recorded, the procedure proceeds to step 15.

At step 14, the computer 1 requests the authentication key 2 to transmit the production number and in response to the request of the production number from the computer 1, the authentication key 2 transmits the production number of the authentication key 2 to the computer 1. The computer 1 receives the production number of the authentication key 2 and records the production number of the authentication key 2 in the production number recorder 21 of the computer 1. This realizes a one-to-one correspondence between the computer 1 and the authentication key 2.

At step 15, determination is made whether or not the production number of the authentication key 2 corresponds to the production number recorded in the computer 1. That is, when the attached authentication key 2 corresponds to the computer 1, the procedure proceeds to step 16 and when the attached authentication key 2 does not correspond to the computer 1, the procedure proceeds to step 17. At step 17, according to a command from the controller 18 of the computer 1, the monitor 16 displays “Authentication key is wrong” thereon.

At step 16, according to a command from the controller 18 of the computer 1, the monitor 16 displays a screen for inputting the user's ID code thereon.

At step 18, the controller 18 determines whether or not the ID code input using the keyboard 14 or the like corresponds to the ID code recorded in the ID code recorder 20 of the computer 1. That is, when the ID code recorded in the computer 1 corresponds to the input ID code, the procedure proceeds to step 19 and when the ID code recorded in the computer 1 does not correspond to the input ID code, the procedure returns to step 16.

At step 19, the computer 1 (controller 18) requests the authentication key 2 to transmit the encryption code, and according to the control of the controller 7 of the authentication key 2, the authentication key 2 transmits the encryption code recorded in the encryption recorder 10 of the authentication key 2 to the computer 1. The controller 18 of the computer 1 collates the encryption code transmitted from the authentication key 2 with the encryption code recorded in the encryption recorder 19 of the computer 1, when both encryption codes correspond to each other, the procedure proceeds to step 20 and both encryption codes do not correspond to each other, the procedure returns to step 11.

When the authentication key 2 is attached to the computer 1 for the first time, it is necessary to record the encryption code in the computer 1 and authentication key 2 to be used, respectively, before connecting the authentication key 2 to the computer 1, so that the encryption codes may correspond to each other in the first time. For example, the encryption code is recorded using the application software installed in the computer 1.

At step 20, the controller 18 permits the use of the computer 1, that is, log-in of one user to the OS (Windows).

At step 21, the computer 1 (controller 18) requests the authentication key 2 to transmit the usage permission number and according to the control of the controller 7 of the authentication key 2, the authentication key 2 transmits the usage permission number recorded in the permission recorder 11 of the authentication key 2 to the computer 1. The controller 18 of the computer 1 determines whether or not the usage permission number transmitted from the authentication key 2 reaches a predetermined number of times, when the usage number reaches the predetermined number of times, the procedure proceeds to step 22 and when the usage number does not reach the predetermined number of times, the procedure proceeds to step 24.

The predetermined number of times in determining whether or not the usage permission number reaches the predetermined number of times is recorded in the recorder 17 of the computer 1.

At step 22, the computer 1 (controller 18) requests the authentication key 2 to transmit the random number and according to the control of the controller 7 of the authentication key 2, the random number generated by the random number generator 5 is invoked and transmitted to the computer 1. After that, the controller 18 of the computer 1 receives the random number and creates the encryption code based on the random number.

For example, when the computer 1 requests the authentication key 2 to transmit the random number, the authentication key 2 fetches 16 bits from the random number data (data of 0, 1) generated by the random number generator 5 and transmits the data of 16 bits to the computer 1. The computer 1 directly sets the received random number of 16 bits as a new encryption code.

At step 23, the computer 1 rewrites the old encryption code recorded in the encryption recorder 19 of the computer 1 to the newly created encryption code and transmits the newly created encryption code to the authentication key 2. The authentication key 2 receives the new encryption code and according to the control of the controller 7, the old encryption code recorded in the encryption recorder 10 of the authentication key 2 is rewritten to the new encryption code.

At step 24, the computer 1 counts up the usage permission number received at step 22 and transmits the number to the authentication key 2. The authentication key 2 receives the new counted-up usage permission number and rewrites the old usage permission number recorded in the permission recorder 11 to the new usage permission number.

As seen from the above-mentioned description, when the controller 18 collates the encryption code of the computer 1 with the encryption code of the authentication key 2 and both encryption codes correspond to each other (after the procedure proceeds from step 19 to step 20), the new encryption code is created on the basis of the random number generated by the random number generator 5 (step 22) and the controller 18 rewrites the encryption code recorded in the encryption recorder 19 of the computer 1 to the new encryption code. At the same time, the controller 7 rewrites the encryption code recorded in the encryption recorder 10 of the authentication key 2 to the new encryption code (step 23).

The code rewriter 23 rewrites the encryption code when the encryption code of the computer 1 corresponds to the encryption code of the authentication key 2 (the procedure proceeds from step 19 to step 20) and the number of times the authentication key 2 permits the use of the computer 1 reaches the predetermined number of times (after the procedure proceeds from step 21 to step 22).

Thus, since the encryption code is created on the basis of the irregular true random number (physical random number) generated by the random number generator 5 and the encryption codes of the computer 1 and authentication key are rewritten, the encryption code is hard to be decoded and information in the computer 1 can be prevented from being leaked through an unauthorized operation of the computer 1.

Furthermore, since the encryption code is rewritten only when the usage permission number to the computer 1 by the authentication key 2 becomes the predetermined number of times (for example, 3, 5 or 10), rewriting timing of the encryption code can be made irregular. As a result, the encryption code is harder to decode.

Furthermore, since the permission unit 24 of the controller 18 prohibits the user from using the computer 1 unless the encryption code of the computer 1 corresponds to the encryption code of the authentication key 2 and the ID code recorded in the computer 1 corresponds to the user's ID code, information stored in the computer 1 can be prevented from being leaked through an unauthorized operation of the computer 1.

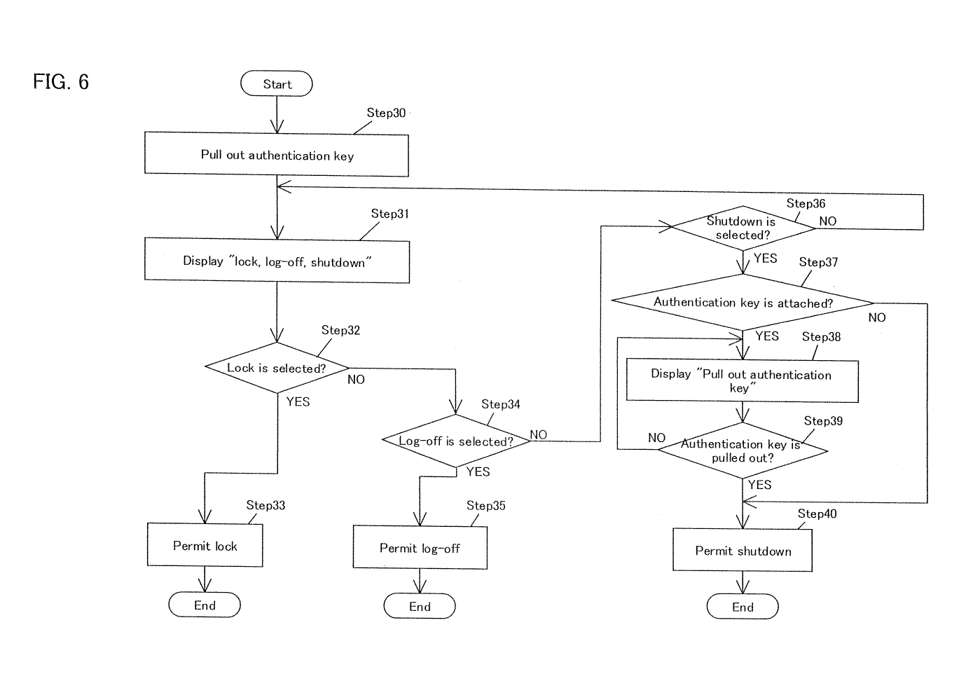

Next, operations of the user authentication system when the authentication key 2 attached to the computer 1 is pulled from the computer 1 after usage permission of the computer 1 will be described referring to a flowchart in FIG. 6.

At step 30, when the authentication key 2 attached to the interface 3 of the computer 1 is pulled out after usage permission of the computer 1, the computer 1 detects that the authentication key 2 has been pulled out and the procedure proceeds to step 31. At step 31, according to a command from the controller 18 of the computer 1, the monitor 16 displays “Lock, log-off, shutdown” thereon so that any of lock, log-off and shutdown may be selected using the keyboard 14 and mouse 15 or the like.

At step 32, the controller 18 of the computer 1 determines whether or not lock is selected. When lock is selected, the procedure proceeds to step 33 and when lock is not selected, the procedure proceeds to step 34.

At step 33, the computer 1 is locked to be unusable. That is, for example, the computer 1 is made inoperable with the input device (the keyboard 14, the mouse 15) or the like and in the case where a predetermined operation is performed using the application software, the current operation state is held.

At step 34, the controller 18 of the computer 1 determines whether or not log-off is selected. When log-off is selected, the procedure proceeds to step 35 and when log-off is not selected, the procedure proceeds to step 36.

At step 35, usage permission of the OS by one user is cancelled, that is, the system is logged off.

At step 36, the controller 18 of the computer 1 determines whether or not shutdown is selected. When shutdown is selected, the procedure proceeds to step 37 and when shutdown is not selected, the procedure returns to step 31.

At step 37, determination is made whether or not the authentication key 2 is attached to the computer 1 again. When the authentication key 2 is attached to the computer 1, the procedure proceeds to step 38 and when the authentication key 2 is not attached to the computer 1, the procedure proceeds to step 40.

At step 38, according to a command from the controller 18 of the computer 1, the monitor 16 displays “Pull out authentication key 2” thereon.

At step 39, the controller 18 of the computer 1 determines whether or not the authentication key 2 is pulled from the computer 1. When the authentication key 2 is pulled out, the procedure proceeds to step 40 and when the authentication key 2 is not pulled out, the procedure returns to step 38. At step 40, the computer 1 is shut down.

As seen from the above-mentioned description, the user authentication system of the computer 1 is provided with a locking unit 25 for locking the computer 1 to be unusable and the locking unit 25 is provided in the controller 18 of the computer 1.

Accordingly, by pulling out the authentication key 2 attached to the interface 3 of the computer 1 after usage permission of the computer 1, the computer 1 can be locked to be unusable without requiring shutdown or the like. For example, when the authorized user of the computer 1 has to leave a work area where he/she operates the computer 1, if only the user pulls out and carries the authentication key 2, the other person cannot operates the computer 1 in the absence of the user in the work area.

When the user intends to shut down the computer 1, shutdown cannot be done without removing the authentication key 2 from the computer 1. Thus, there is no possibility of forgetting to pull out the authentication key 2 at shutdown.

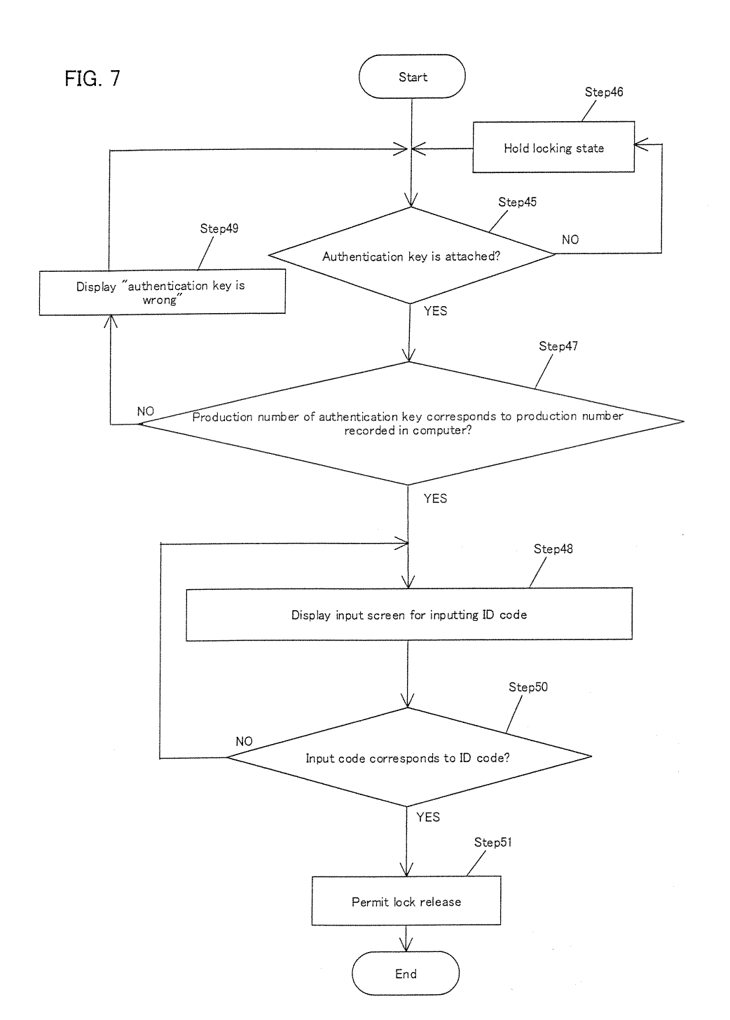

Next, operations of the user authentication system in the state where the computer 1 is locked will be described referring to a flowchart in FIG. 7.

At step 45, the controller 18 of the computer 1 determines whether or not the authentication key 2 is attached to the interface 3 (USB) of the computer 1. When the authentication key 2 is attached to the interface 3, the procedure proceeds to step 46 and when the authentication key 2 is not attached to the interface 3, the procedure proceeds to step 47. At step 46, the locking state of the computer 1 is held.

At step 47, determination is made whether or not the production number of the authentication key 2 corresponds to the production number recorded in the computer 1. That is, when the attached authentication key 2 corresponds to the computer 1, the procedure proceeds to step 48 and when the attached authentication key 2 does not correspond to the computer 1, the procedure proceeds to step 49. At step 49, according to the command from the controller 18 of the computer 1, the monitor 16 displays “Authentication key is wrong” thereon.

At step 48, according to the command from the controller 18 of the computer 1, the monitor 16 displays a screen for inputting the user's ID code thereon.

At step 50, in the controller 18, determination is made whether or not the ID code input with the keyboard 14 or the like connected to the computer 1 corresponds to the ID code recorded in the ID code recorder 20 of the computer 1. That is, when the ID cord recorded in the computer 1 corresponds to the input ID code, the procedure proceeds to step 51 and when the ID cord recorded in the computer 1 does not correspond to the input ID code, the procedure returns to step 48.

At step 51, locking of the computer 1 is released and thus, the computer 1 is made operable with the input device (the keyboard 14, the mouse 15). In the case where the predetermined operation is performed using the application software, the operation state held immediately before locking is released.

As seen from the above-mentioned description, the user authentication system of the computer 1 is provided with a lock releasing unit 26 for putting the computer 1 from the locking state into the usable state and the lock releasing unit 26 is provided in the controller 18 of the computer 1.

Accordingly, when the authentication key 2 is attached to the computer 1 in the locking state, using the application software, the subsequent operation can be performed from the state immediately before locking.

The present invention is not limited to the above-mentioned embodiment.

That is, in the above-mentioned embodiment, after the encryption code of the computer 1 corresponds to the encryption code of the authentication key 2, according to the control of the controller 7 of the authentication key 2, the random number generated by the random number generator 5 at all times is fetched by only a predetermined bits. Alternatively, a random number generation controller (random number generation control function) that controls so that the random number generator 5 generates the random number when the encryption code is rewritten may be provided in the controller 7 of the authentication key 2. Thus, after the encryption code of the computer 1 corresponds to the encryption code of the authentication key 2, the random number generation controller in the controller 7 of the authentication key 2 may allow the random number generator 5 to generate the random number of predetermined bits. In other words, only when the encryption code is rewritten, the random number generator 5 may generate the random number.

In the above-mentioned embodiment, determination is made whether or not the ID code input from the outside corresponds to the ID code recorded in the ID code recorder 20 of the computer 1 (step 16, step 18) and after that, the encryption code of the computer 1 is collated with the encryption code of the authentication key 2 (step 19). The following alternative is acceptable. The steps 16 and 18 are cancelled and determination is made whether or not the production number of the authentication key 2 corresponds to the production number recorded in the computer 1 (step 15) and then the encryption code of the computer 1 is collated with the encryption code of the authentication key 2 (step 19).

What is claimed is:

1. A computer user authentication system comprising: a computer that records an encryption code therein; and an authentication key that stores an encryption code therein, the computer having a controller for collating the encryption code of the computer with the encryption code of the authentication key and for permitting the use of the computer when both encryption codes correspond to each other, wherein
the authentication key comprises
a random number generator for generating a random number on the basis of a noise signal generated by a noise source and
a code rewriter for creating a new encryption code on the basis of the random number generated by the random number generator when the encryption code of the computer corresponds to the encryption code of the authentication key and for rewriting the encryption code recorded in the authentication key to the new encryption code, and
the computer comprises
a code rewriter for creating the new encryption code on the basis of the random number generated by the random number generator when the encryption code of the computer corresponds to the encryption code of the authentication key and for rewriting the encryption code recorded in the computer to the new encryption code.

2. The computer user authentication system according to claim 1, wherein the authentication key includes a random number generation controller for controlling the random number generator so as to generate the random number when the code rewriter of the authentication key rewrites the encryption code to the new encryption code.

3. The computer user authentication system according to claim 1, wherein the code rewriter rewrites the encryption code when the encryption code of the computer corresponds to the encryption code of the authentication key and the number of times that the authentication key permits the use of the computer reaches a predetermined number of times.

4. The computer user authentication system according to claim 1, wherein an ID code is recorded in the computer and the controller of the computer permits the use of the computer when the encryption code of the computer corresponds to the encryption code of the authentication key and the code input to the computer corresponds to the ID code.

5. The computer user authentication system according to claim 1, wherein the authentication key can be connected to an interface of the computer and the authentication key transmits the encryption code of the authentication key to the computer when the authentication key is connected to the interface of the computer.

6. The computer user authentication system according to claim 1, wherein the controller of the computer includes a locking unit for making the computer unusable when the authentication key connected to the interface of the computer is pulled from the interface so that computer operation may be performed from the state immediately before the pulling-out of the authentication key when the authentication key is connected to the interface of the computer again.
